(19) United States
(12) Patent Application Publication
(10) Pub. No.: US 2012/0305741 A1
(43) Pub. Date: Dec. 6, 2012

(54) Gravity-Stabilized Sensor Mount for Moving Platform

(75) Inventor: Itzhak Sapir, Irvine, CA (US)

(73) Assignee: ISC8 Inc., Costa Mesa, CA (US)

(21) Appl. No.: 13/457,566

(22) Filed: Apr. 27, 2012

Related U.S. Application Data
(60) Provisional application No. 61/491,685, filed on May 31, 2011.

(51) Int. Cl. F16M 13/00

(52) U.S. Cl. 248/636; 248/349.1

(57) ABSTRACT

A gravity-stabilized sensor mount is disclosed having a base member pivotably coupled to a multi-axis gimbal with damping means disposed between the base member and one or more gimbal elements. The gimbal assembly is coupled to a connecting member which may, in turn, be coupled to a moving platform such as a land vehicle, aircraft or marine vessel. The base member may have a payload such as a sensor system mounted on it and is provided with counter-balances so that the base member remains level in two horizontal axes with respect to the surface of the Earth regardless of the vertical orientation of the connecting member.

### CROSS-REFERENCE TO RELATED APPLICATIONS

This application claims the benefit of U. S. Provisional Patent Application No. 61/491,685, filed on May 31, 2011 entitled “Gravity Stabilized Sensor Bench for Moving Platforms” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to mounting devices and fixtures.

More specifically, the invention relates to a gravity-stabilized mount or fixture for a sensor system for use on moving platforms such as ground-based or naval applications that operates without the need for active electronics or power.

2. Description of the Related Art

In certain moving sensor platform applications (e.g., land vehicles and ocean vessels), there is a need for a motion/vibration stabilized sensor mount for affixing or housing optical or other sensors that require level (i.e., horizontal in two axes) orientation for proper operation while the vehicle or vessel platform is in motion.

As the vehicle or vessel upon which the sensor platform is affixed travels through rough terrain or in rough seas, the sensor mount must still remain level with respect to the surface of the Earth while maintaining a fixed relationship with the heading of the vehicle or vessel.

Prior art stabilized sensor mounts are of the active type. In such systems, tilt sensors are rigidly mounted on the moving platform and sense the platform inclination in two axes. The inclination readings are then fed into control electronics that in turn drive motors or actuators to keep the gimbaled sensor mount level with respect to the surface of the Earth.

The gravity-stabilized sensor mount of the invention uses the Earth's gravity to achieve the required goal of maintaining the sensor mount surface substantially parallel to the surface of the Earth. There is no requirement for expensive and complex electronic tilt sensors, control electronics or actuators and thus no need for a power source. The desired performance is achieved through the use of a purely mechanical, self-leveling system.

No such unpowered solution is known to be used for the above described applications, i.e., no prior art solution is known for moving sensor platform stabilization using a passive operation concept in cooperation with natural physical forces.

### BRIEF SUMMARY OF THE INVENTION

A gravity-stabilized sensor mount is disclosed having a base member pivotably coupled to a multi-axis gimbal with damping means disposed between the base member and one or more gimbal elements. The gimbal assembly is coupled to a connecting member which may, in turn, be coupled to a moving platform such as a land vehicle, aircraft or marine vessel.

The base member may have a payload such as a sensor system mounted on it and is provided with counter-balances so that the base member remains level in two horizontal axes with respect to the surface of the Earth regardless of the vertical orientation of the connecting member.

In a first aspect of the invention, a sensor mount is disclosed comprising a base member, a multi-axis gimbal assembly defining a first vertical axis. The invention may comprise damper means disposed between the base member and the gimbal assembly for absorbing kinetic energy. The base member is pivotably coupled to the gimbal assembly whereby the net gravitational forces acting on the base member have zero moment about the first vertical axis so that the base member remains level irrespective of the angle of the first vertical axis.

In a second aspect of the invention, the sensor mount further comprises a payload having a first mass and payload counter-balance means for providing a second mass at one or more predetermined positions on the base member whereby the net gravitational forces acting on the base member have zero moment about the first vertical axis so that the base member remains level irrespective of the angle of the first vertical axis.

In a third aspect of the invention, the payload comprises at least one electro-optical sensor for generating an electrical output in response to an input of a predetermined range of the electromagnetic spectrum.

In a fourth aspect of the invention, the damper means is a hydraulic damper.

In a fifth aspect of the invention, the damper means is a pneumatic damper.

In a sixth aspect of the invention, the damper means is a friction damper.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts an isometric projection view of the sensor mount of the invention.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

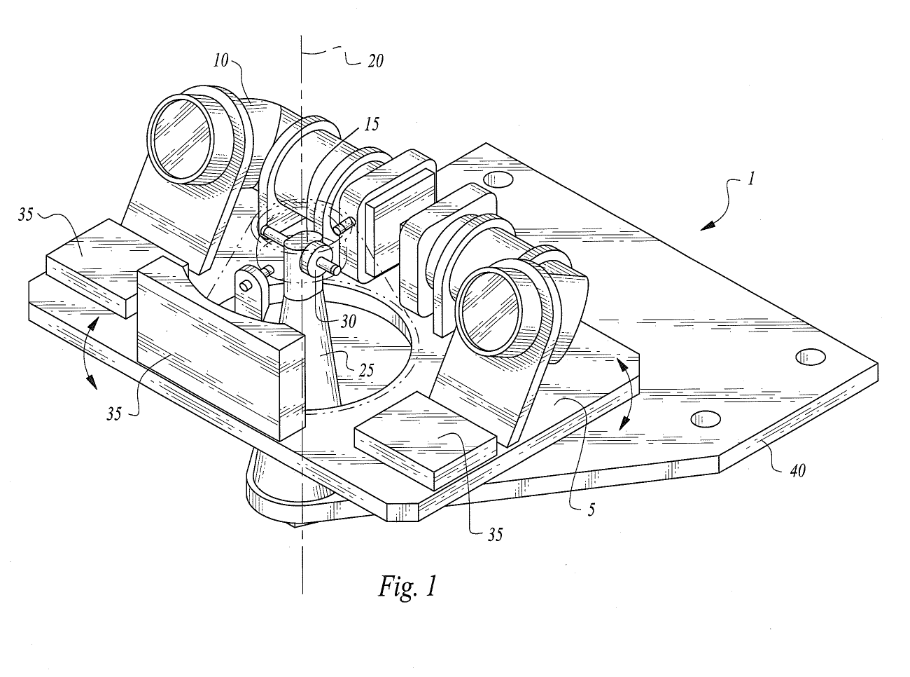

Turning now to FIG. 1, a gravity-stabilized sensor mount 1 is disclosed.

A preferred embodiment of sensor mount 1 comprises a base member 5 used for instance, for affixing a payload 10 such as an electro-optic sensor system thereto.

Sensor mount 1 of the invention comprises a multi-axis gimbal assembly 15 such as a two-axis gimbal assembly defining a first vertical axis 15 and is coupled to an upwardly depending connecting member 25.

Gimbal assembly 15 is pivotably coupled to base member 5 so that base member 5 has a predetermined freedom of inclination movement about two horizontal axes.

Kinetic energy damper means 30 is preferably disposed between the base member 5 and at least one gimbal assembly 15 element such as a gimbal pivot shaft for absorbing kinetic vibration energy and movement to permit a smooth travel of base member 5 as it rotates about the plurality of axes.

Damper means 30 may comprise, for instance, a hydraulic damper, a pneumatic damper, a friction damper or other known energy or vibration damping means or shock absorbing means.

Base member 5 is pivotably coupled to gimbal assembly 15 and configured so as to be balanced such that the net forces acting on the base member 5 have zero moment about the first vertical axis 20 (i.e., the surface of base member 5 is level in two horizontal axes with respect to the surface of the Earth.).

Sensor mount 1 may comprise a payload 10 having a first mass and one or more payload counter-balance means 35 for providing a second mass at one or more predetermined positions on base member 5 which may be user configurable whereby the net forces have a zero moment about first vertical axis 20.

Payload 10 may comprise at least one electro-optical sensor for generating an electrical output in response to an input of a predetermined range of the electromagnetic spectrum such as a LIDAR or LWIR electro-optic sensor system such as is disclosed in U.S. patent application Ser. No. 13/338,332 filed on Dec. 28, 2011 and entitled “Sensor System Comprising Stacked Micro-Channel Plate Detector” now pending, the entirely of which is incorporated herein by reference.

Optionally, connection member 25 of sensor mount 1 may be fixedly coupled to a bracket 40 for ease and stability of connecting sensor mount 1 to a moving platform.

The sensor mount of the invention therefore provides a passive, self-leveling, gravity-stabilized sensor mount for a payload such as an electro-optic sensor system.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A sensor mount comprising:
a base member,
a multi-axis gimbal assembly defining a first vertical axis,
the base member pivotably coupled to the gimbal assembly whereby the net gravitational forces acting on the base member have zero moment about the first vertical axis irrespective of the angle of the first vertical axis.

2. A sensor mount comprising:
a base member,
a multi-axis gimbal assembly defining a first vertical axis,
damper means disposed between the base member and the gimbal assembly for absorbing kinetic energy,
the base member pivotably coupled to the gimbal assembly whereby the net gravitational forces acting on the base member have zero moment about the first vertical axis irrespective of the angle of the first vertical axis.

3. The sensor mount of claim 2 further comprising a payload having a first mass, and,
payload counter-balance means for providing a second mass at one or more predetermined positions on the base member whereby the net gravitational forces acting on the base member have zero moment about the first vertical axis irrespective of the angle of the first vertical axis.

4. The sensor mount of claim 3 wherein the payload comprises at least one electro-optical sensor for generating an electrical output in response to an input of a predetermined range of the electromagnetic spectrum.

5. The sensor mount of claim 3 wherein the damper means is a hydraulic damper.

6. The sensor mount of claim 3 wherein the damper means is a pneumatic damper.

7. The sensor mount of claim 3 wherein the damper means is a friction damper.
